(19) United States
(12) Patent Application Publication
(10) Pub. No.: US 2025/0279706 A1
(43) Pub. Date: Sep. 4, 2025

(54) ELECTRIC MACHINE, MOTOR VEHICLE HAVING AN ELECTRIC MACHINE, AND METHOD FOR OPERATING AN ELECTRIC MACHINE

(71) Applicant: AUDI AG, Ingolstadt (DE)

(72) Inventor: Daniel RUPPERT, Lenting (DE)

(21) Appl. No.: 19/056,587

(22) Filed: Feb. 18, 2025

(30) Foreign Application Priority Data
Feb. 29, 2024 (DE) 102024105731.9

(51) Int. Cl. H02K 11/35; B60L 50/51

(52) U.S. Cl. CPC H02K 11/35; B60L 50/51; B60L 2210/40; B60L 2220/14

(57) ABSTRACT

An electric machine is disclosed, and may comprise a static section and a rotor rotatably mounted relative to the static section. The static section may have a control device configured to generate control signals for controlling operation of the electric machine. The rotor may have at least one acquisition device for acquiring and/or generating at least one item of rotor information relating to operation of the rotor. The control signals for controlling the operation of the electric machine may be generated depending on the at least one item of rotor information. The at least one item of rotor information may be transmittable from the at least one acquisition device to the control device via a transmitter of the rotor and a receiver of the static section. The at least one item of rotor information may be transmittable in a contact-free manner and by optical signals from the transmitter to the receiver.

### BACKGROUND

### Technical Field

The present disclosure relates to an electric machine designed as an externally excited synchronous machine.

### Description of the Related Art

Electric machines comprise a stator and a rotor, wherein electromagnetic interactions between field coils and, optionally, permanent magnets cause a conversion of electrical energy into kinetic energy, and vice versa. Permanent magnets are not used in externally excited synchronous machines. Instead, both the rotor and the stator have field coils to be energized, which are often referred to as stator and rotor windings, respectively. One advantage of externally excited synchronous machines is that there are additional degrees of freedom in the control and configuration of the electric machine.

A disadvantage of an externally excited synchronous machine is the fact that, during its operation, information is often required that describes the current operation of the rotor and is therefore ideally acquired or available on the rotor side. Nevertheless, this information is typically required on a control device's part, said device being arranged on a static or non-rotating section of the electric machine. Due to the relative movement between the static section and the rotor, it is not easy to provide this information to the control device. One conceivable approach in this regard is to implement the information transmission via a contact-based coupling between the static section and the rotor, such as, for example, via a sliding contact. However, this approach is prone to errors and leads to severe wear on the components involved. Another conceivable approach is to determine the required information as part of modeling or approximation methods, such as, for example, by way of computer-implemented algorithms, so that the information transmission from the rotor to the static section is not necessary. However, this is complex and often produces inaccurate results.

A further approach in this regard is described in EP0598924A1. This published patent application describes an electric machine intended for use in the field of machine tools, in which electrical signals are converted into optical signals and transmitted from a static unit to a rotating unit.

### BRIEF SUMMARY

The present disclosure provides an improved concept relating to an electric machine, in particular with regard to the widest possible fields of application for the concept of transmitting information from the rotor to the static section by way of optical signals.

The present disclosure provides an electric machine of the type mentioned at the outset in that a drive torque for a motor vehicle can be generated by way of this electric machine, wherein the electric machine may be connectable to a drive train of the motor vehicle, wherein the electric machine comprises a static section and a rotor rotatably mounted relative to the static section, wherein the rotor may have at least one acquisition device for acquiring and/or generating at least one item of rotor information relating to the operation of the rotor, wherein the static section may have a control device which is configured to generate control signals for controlling the operation of the electric machine depending on the at least one item of rotor information, wherein the at least one item of rotor information may be transmittable from the at least one acquisition device to the control device via a transmitter of the rotor and a receiver of the static section, wherein the at least one item of rotor information may be transmittable in a contact-free manner and by way of optical signals from the transmitter to the receiver.

The present disclosure utilizes the advantages of the concept in which the item of rotor information on the rotor's part is acquired, such as, for example, by measurement, and then transmitted to the static section, in the context of electric machines that are provided to generate a traction torque, in particular a drive or braking torque, for a motor vehicle.

The above-mentioned disadvantage regarding the inaccurate results for the item of rotor information due to the use of modeling or approximation methods is thus overcome, since the rotor-side acquisition or generation of the item of rotor information makes the use of these methods superfluous. The disadvantage of the wear and tear that occurs with contact-based coupling is also overcome, since the coupling that enables the information transmission can be implemented completely contact-free by way of the optical signals.

A particularly relevant circumstance in the field of electric machines provided as traction motors for motor vehicles is the fact that, in comparison to many other areas of application, there is often a strong temporal variability in the operating parameters of the electric machine. For example, acceleration phases, in which a high drive torque is generated by the electric machine, and deceleration or recuperation phases, in which a braking torque is generated by the electric machine, can alternate directly one after the other. As a result, the behavior of the electric machine is difficult and complex to model, which means that the modeling or approximation methods mentioned above are hardly a suitable way of obtaining rotor information, especially in this field of application.

The general aspects explained above with regard to externally excited synchronous machines are in principle equally applicable or transferable to the electric machine according to the present disclosure. Specifically, the electric machine according to the present disclosure can be three-phase machine. The electric machine can be implemented as an internal or external rotor. The motor vehicle may be a purely electric vehicle or a hybrid vehicle that has an internal combustion engine for generating a drive torque in addition to the electric machine. In some embodiments, the motor vehicle may be a plug-in hybrid vehicle.

The drive train of the motor vehicle can be understood to mean those components of the motor vehicle that are in mechanical operative contact with the electric machine for transmitting the drive torque from the electric machine to the wheels of the motor vehicle. The electric machine may thus have an open drive shaft that is connectable to a shaft of the drive train, for example via a clutch. Conceivable components of the drive train are shafts, gears, in particular transmission and/or differential gears, clutches and the like. Details in this regard are well known to those skilled in the art and are therefore not explained in more detail herein.

The static section can be understood to mean the totality of all components of the electric machine that are arranged fixed to the vehicle as installed in the motor vehicle. The static section comprises the stator of the electric machine. A housing of the electric machine that houses the rotor and the stator can also be understood to mean a component of the static section.

The rotor is the section of the electric machine that is rotatably mounted relative to the static section or the stator. The rotor comprises a rotor shaft that carries the other components of the rotor, such as the acquisition device and, optionally, a laminated core and the rotor windings. The rotor, in particular the rotor shaft, is rotatably mounted on the static section, in particular the housing, via at least one bearing. A section of the rotor shaft that protrudes from the housing may form the above-mentioned drive shaft.

The acquisition device can be understood to mean any device or apparatus that can be used to acquire and/or generate the item of rotor information. The acquisition device may be a measuring device configured to acquire the item of rotor information, wherein the item of rotor information relates to the physical quantity that can be acquired by way of the respective measuring device. The corresponding measured quantity, i.e., the item of rotor information, relates to a current state of the rotor, wherein knowledge of this information is at least advantageous or even essential in the context of the current operation of the electric machine. The item of rotor information, at least one of the items of rotor information, or each item of rotor information may be acquired separately for each rotor winding if the rotor has several rotor windings.

Electrical signals present on the rotor side, in particular analog or binary signals, may be generated by way of the at least one acquisition device, and may serve as information carriers for the at least one item of rotor information. According to the present disclosure, the electrical signals present on the rotor side may be converted into optical signals. This conversion may occur by way of at least one illuminant, which forms the transmitter, wherein the optical signals, which can also be referred to as light signals, are emitted by the at least one illuminant. The optical signals then also serve as information carriers for the at least one item of rotor information. The illuminant may be a light-emitting diode. The light signals may comprise light whose wavelengths can be found in the optically visible range.

With regard to the conversion of the electrical signals into the optical signals, the rotor may include a processing device that is configured to control the transmitter using the rotor-side electrical signals in such a way that the optical signals generated by way of the illuminant, which serve as information carriers for the at least one item of rotor information, are generated. The processing device is in particular a microcontroller. The processing device together with the illuminant therefore convert the rotor-side electrical signals into the optical signals.

The receiver may have at least one light detector for detecting the optical signals. The light detector can also be referred to as a receiving diode. The receiver may be used to convert the detected optical signals into electrical signals present on the stator side as information carriers for the at least one item of rotor information. The receiver may therefore convert the optical signals into the electrical signals on the stator side. These signals may then be transferred to the control device. The control device may form control electronics, which are preferably configured as a microcontroller.

In some embodiments, the acquisition device may be at least one current sensor or may comprise at least one current sensor. At least one current information may be acquirable as the item of rotor information or as at least one of the items of rotor information by way of the at least one current sensor, which relates to a current electrical current flowing in at least one rotor winding of the rotor. A measured value relating to the current electrical current intensity is acquirable by way of the current sensor.

In some embodiments, the acquisition device may be at least one voltage sensor or may comprise at least one voltage sensor. At least one item of voltage information may be acquirable as the item of rotor information or as at least one of the items of rotor information by way of the at least one voltage sensor, which relates to a current electrical voltage applied to at least one rotor winding of the rotor. A measured value relating to the current electrical voltage applied to the respective rotor winding may be acquirable by way of the voltage sensor.

In addition to the current sensor and/or the voltage sensor, the acquisition device may have a filter by way of which the respective analog measurement signal containing noise can be filtered. A high-pass filter, a low-pass filter or a band filter is conceivable in this regard. The acquisition device may have an amplifier by way of which the level of the, in particular filtered, signal may be adjusted to a value required for an analog-digital converter. The digital signal may then be transmitted from the analog-digital converter to the processing device.

The acquisition device may be at least one rotational position sensor or may comprise at least one rotational position sensor, wherein at least one item of rotational position information relating to a current rotational position of the rotor may be acquirable by way of the at least one rotational position sensor as the item of rotor information or as at least one of the items of rotor information. The rotational position sensor may be a position sensor by way of which a measured value relating to the current position of a component of the rotor is acquirable.

In some embodiments, the item of current information, the item of voltage information and the item of rotational position information may be acquired, and this information may be used within the context of a control loop. The control device may thus be configured to control the operation of the electric machine in such a way that corresponding target values may be specified for the rotor-side values of the electrical current and/or the electrical voltage, which in turn may depend on the current rotational position of the rotor. The item of current information and the item of voltage information may be used to determine the deviation between the target values and the current actual values, wherein, depending thereof, the control signals are adjusted or specified accordingly.

In some embodiments, the acquisition device may be at least one temperature sensor or may comprise at least one temperature sensor. At least one item of temperature information relating to a current temperature of the rotor, in particular of at least one rotor winding, may be acquirable as the item of rotor information or as at least one of the items of rotor information by way of the at least one temperature sensor. Since the electrical resistances of the rotor windings depend on the temperature of the conductor wire forming the rotor windings, taking the temperature into account in the context of controlling the electric machine is correspondingly advantageous. The item of temperature information may thus also be taken into account in particular in the context of the control loop already explained.

With regard to the transmission of the optical signals from the transmitter to the receiver, the transmitter may move along an annular trajectory during the rotation of the rotor, with the receiver being annular and arranged next to the annular trajectory. The annular trajectory, which may also be referred to as the movement path, and the annular receiver may be arranged concentrically and/or axially offset with respect to an axis of rotation of the electric machine. Due to the annular shape of the receiver and the specific geometric arrangement of these components relative to one another, a relative distance between the transmitter and the receiver remains at least almost constant during the rotation of the rotor, so that the transmission of the optical signals can take place without interruption and reliably. Analogously or alternatively, the transmitter may be arranged annularly and concentrically with respect to an axis of rotation of the rotor, wherein the receiver is arranged next to the transmitter. In the context of this embodiment, too, the relative distance between the transmitter and the receiver remains at least almost constant.

The electric machine according to the present disclosure preferably has at least one transmission device by way of which a power provided for energizing at least one rotor winding of the rotor may be transmittable inductively from the static section to the rotor. Consequently, a wireless transmission from the static section to the rotor may also occur for the power provided for generating the traction torque, so that no components subject to wear are required with regard to the transmission of this power either.

The at least one transmission device for inductively transmitting the power may preferably have at least one stator-side induction coil and at least one rotor-side induction coil. The stator-side induction coil may be connectable to an energy storage device of the motor vehicle designed to store electrical energy via an inverter. The energy storage device may be, for example, a lithium-ion battery. The inverter may be configured to convert the direct voltage provided on the energy storage device's part into an alternating voltage that is required for power transmission by induction. The rotor-side induction coil may be connected to the at least one rotor winding via a rectifier. The rectifier may be configured to convert the alternating voltage present on the rotor-side induction coil's part into a direct voltage that is required to energize the at least one rotor winding.

The control device may preferably be configured to generate the control signals for controlling the operation of the inverter depending on the at least one item of rotor information. In particular, the value of the voltage generated by way of the inverter and which is generated at its output connected to the transmission device, may be determined based on the control signals. The power transmitted from the transmission device to the rotor may depend thereon, which in turn may determine the values for the electrical voltage and the electrical current present at the rotor's or the rotor windings' part.

The present disclosure also relates to a motor vehicle. According to the present disclosure, the motor vehicle may comprise an electric machine as described above, wherein the electric machine is connected to a drive train of the motor vehicle. All features, advantages and aspects explained in connection with the electric machine according to the present disclosure are transferable equally to the motor vehicle according to the present disclosure, and vice versa.

Finally, the present disclosure relates to a method for operating an electric machine which is configured as an externally excited synchronous machine. According to the present disclosure, a drive torque for a motor vehicle may be generated by way of the electric machine, wherein the electric machine may be connectable to a drive train of the motor vehicle, wherein the electric machine comprises a static section and a rotor rotatably mounted relative to the static section, wherein the rotor may have at least one acquisition device by way of which at least one item of rotor information relating to the operation of the rotor is acquired and/or generated, wherein the static section may have a control device by way of which control signals for controlling the operation of the electric machine are generated depending on the at least one item of rotor information, wherein the at least one item of rotor information may be transmitted from the at least one acquisition device to the control device via a transmitter of the rotor and a receiver of the static section, wherein the at least one item of rotor information may be transmitted in a contact-free manner and by way of optical signals from the transmitter to the receiver. All features, advantages and aspects explained in connection with the electric machine according to the present disclosure and the motor vehicle according to the present disclosure are equally transferable to the method according to the present disclosure, and vice versa.

### BRIEF DESCRIPTION OF THE SEVERAL VIEWS OF THE DRAWINGS

FIG. 1 shows a schematic diagram of an exemplary embodiment of a motor vehicle comprising an electric machine according to the present disclosure.

FIG. 2 shows a schematic representation of the electric machine of the motor vehicle of FIG. 1.

FIG. 3 shows a flow chart of a method according to according to an exemplary embodiment of the present disclosure.

FIG. 4 shows a first exemplary embodiment of a geometric arrangement of a transmitter and a receiver of the electric machine of FIG. 2.

FIG. 5 shows a second exemplary embodiment of a geometric arrangement of a transmitter and a receiver of the electric machine of FIG. 2.

### DETAILED DESCRIPTION

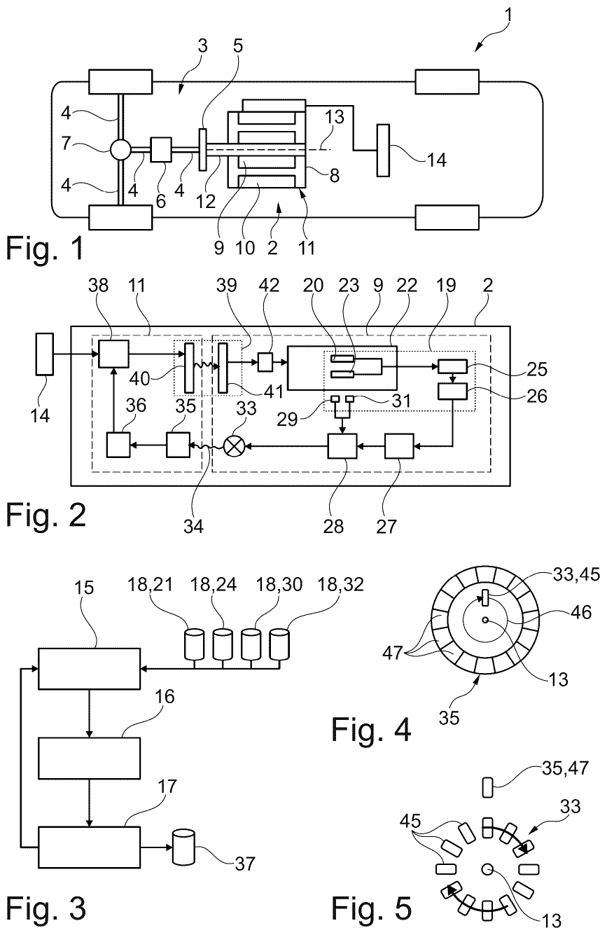

FIG. 1 shows a schematic diagram of a motor vehicle 1 according to the present disclosure according to an exemplary embodiment from above. Motor vehicle 1 has an electric machine 2 according to the present disclosure, which is connectable to a drive train 3 of motor vehicle 1 and may be connected according to the configuration shown in FIG. 1. A drive torque may be generated for motor vehicle 1 by way of electric machine 2, which is transmitted to components of drive train 3. Shafts 4, a clutch 5, a transmission gear 6, and a differential gear 7 may be provided as components of drive train 3, wherein further details regarding drive train 3 are not explained in more detail here.

Electric machine 2 may comprise a housing 8 which houses a rotor 9 and a stator 10. Rotor 9 may be located in a section which is radially further inward than stator 10, so that electric machine 2 forms an internal rotor. Electric machine 2 may be an externally excited synchronous machine. Accordingly, windings may be provided on both the rotor 9 and the stator 10.

Rotor 9 may comprise a rotor shaft 12 which may be rotatably mounted about an axis of rotation 13. Rotor shaft 12 or rotor 9 may be rotatably mounted on housing 8 via bearings not shown in detail in the figures. A section of rotor shaft 12 that protrudes from the housing 8 may form a drive shaft and may be connected to drive train 3 via clutch 5. Stator 10 may form part of a static section 11 of electric machine 2 which is stationary with respect to the other components of motor vehicle 1 or a vehicle body.

Motor vehicle 1 may comprise an electrical energy storage device 14, which may be a lithium-ion battery and by way of which energy may be provided for generating the drive torque by way of electric machine 2. Although motor vehicle 1 shown in FIG. 1 is a purely electric vehicle, the motor vehicle may also be a hybrid vehicle.

FIG. 2 shows a schematic view of electric machine 2. Rotor 9 and static section 11 are indicated in this illustration as dashed boxes. FIG. 3 shows a flow chart of a method according to an exemplary embodiment of the present disclosure, which is explained below with reference to electric machine 2 shown in FIG. 2 and motor vehicle 1 shown in FIG. 1. The method comprises steps 15 to 17.

In the context of first step 15, several items of rotor information 18 relating to the operation of rotor 9 may be acquired or generated by way of an acquisition device 19.

Acquisition device 19 may comprise a current sensor 20, by way of which an item of current information 21 may be acquired as one of the items of rotor information 18. Item of current information 21 relates to a current electrical current that flows in a rotor winding 22 of rotor 10. Furthermore, acquisition device 19 may comprise a voltage sensor 23, by way of which an item of voltage information 24 may be acquired as one of the items of rotor information 18. Item of voltage information 24 relates to a current electrical voltage that is applied to rotor winding 22. It should be understood that several rotor windings 22 may be provided on the rotor 9, for which items of information 21, 24 are each acquired separately.

The analog measurement signals acquired by current sensor 20 and voltage sensor 23 may be processed by a filter 25 and an amplifier 26 of acquisition device 19. Filter 25 may be a high-pass filter, a low-pass filter or a band filter in order to clean the measurement signals containing noise. The level of the measurement signals may be adjusted by way of amplifier 26 so that the measurement signals may then be digitized by way of an analog-digital converter 27 and passed on to a processing device 28.

Furthermore, acquisition device 19 may comprise a rotational position sensor 29, which may be configured as a position sensor and by way of which an item of rotational position information 30 may be acquired as one of the items of rotor information 18. Rotational position information 30 relates to a current rotational position of rotor 9.

Finally, acquisition device 19 may comprise a temperature sensor 31, by way of which an item of temperature information 32 may be acquired as one of the items of rotor information 18. Item of temperature information 32 relates to the current temperature of rotor 9, specifically the temperature of rotor windings 22.

Items of information 30, 32 may then be passed to processing device 28, which may be configured as a microcontroller, so that all of the acquired items of rotor information 18 are present at the processing device 28 as electrical digital signals. In next step 16 of the method, these signals may be converted into optical signals, which can also be referred to as light signals. For this purpose, processing device 28 may be connected to a transmitter 33, which may be an illuminant comprising, for example, at least one light-emitting diode. Processing device 28 may control transmitter 33 in such a way that the optical signals generated by transmitter 33 act as an information carrier for the item of rotor information 18. In the course of step 16, a contact-free transmission 34 of the item of rotor information 18 may occur from rotor 9 to stationary section 11 by way of the optical signals. For this purpose, a receiver 35 may be provided on the stationary section 11, which may comprise at least one light sensor. The optical signals may be converted back into electrical signals by way of receiver 35, which act as information carriers with regard to items of rotor information 18. These signals may then be transmitted to a control device 36 provided on the static section 11.

In next step 17, control signals 37 may be generated based on items of rotor information 18 and by way of control device 36 and output to an inverter 38. The direct voltage provided by energy storage device 14 may be converted into an alternating voltage by way of inverter 38. The value of the alternating voltage generated on the output side by way of inverter 38 may depend on control signals 37 and may be used to energize rotor windings 22 in the context of the operation of electric machine 2.

To transmit the alternating voltage generated by inverter 38 from static section 11 to rotor 9, electric machine 2 may have a transmission device 39, by way of which the corresponding power may be inductively transmitted from static section 11 to rotor 9. Transmission device 39 may have a stator-side induction coil 40 connected to inverter 38, which functions as a power transmitter. Furthermore, transmission device 39 may also comprise a rotor-side induction coil 41, which functions as a power receiver. Rotor-side induction coil 41 may be connected to a rectifier 42 of rotor 9, via which the transmitted power may be supplied to rotor windings 22. Then, in order to close the existing control loop, the method may be continued again at step 15 with the acquisition or updating of the items of rotor information 18.

A central advantage of the present disclosure relates to the fact that the transmission of item of rotor information 18 from rotor 9 to static section 11 takes place in a contact-free manner and by way of the optical signals. Particularly advantageously, the transmission of the power by way of transmission device 39 also takes place in a contact-free manner, so that the rotation of rotor 9 causes as little wear as possible and, moreover, a reliable transmission of the item of rotor information 18, and, optionally, the power via transmission device 39, is ensured.

Below, additional specific aspects regarding the structure or geometric arrangement of transmitter 33 and receiver 35 are explained. FIG. 4 shows a first exemplary embodiment and FIG. 5 shows a second exemplary embodiment in this regard.

In the first embodiment shown in FIG. 4, transmitter 33, which in this case may be formed from a light-emitting diode 45, may move along an annular trajectory 46 due to the rotation of rotor 9. Receiver 35 may comprise several receiving diodes or light detectors 47, which may be arranged in an annular manner next to annular trajectory 46. The optical signals generated by way of light-emitting diode 45 of the transmitter 33 may be emitted radially outward and then reach respective opposite light detector 47.

In the context of the second embodiment shown in FIG. 5, transmitter 33 may be formed from several annularly arranged light-emitting diodes 45. This annular shape may extend concentrically about axis of rotation 13, so that the rotation of rotor 9 may cause a circular movement of the light-emitting diodes along the direction of the correspondingly formed ring, indicated by corresponding arrows. Receiver 35, which may be stationary in relation to stationary section 11 and may be formed from a receiving diode or a light detector 47, may be arranged next to transmitter 33 or light-emitting diodes 45. The optical signals generated by light-emitting diodes 45 of transmitter 33 may be emitted radially outwards on all sides, so that the optical signals always reach light detector 47 from one of light-emitting diodes 45.

Although the annular shapes shown in FIGS. 4 and 5 relating to transmitter 35 or receiver 36 are arranged concentrically to one another and have different radii, they can also be arranged in different positions with respect to an axial direction running along axis of rotation 13, in which case the radii can be identical. In both embodiments explained with reference to FIGS. 4 and 5, it is advantageous that a relative distance between transmitter 33 and receiver 35 remains almost constant, so that a reliable and uninterrupted transmission of items of rotor information 18 is ensured.

German patent application no. 102024105731.9, filed Feb. 29, 2024, to which this application claims priority, is hereby incorporated herein by reference in its entirety.

Aspects of the various embodiments described above can be combined to provide further embodiments. In general, in the following claims, the terms used should not be construed to limit the claims to the specific embodiments disclosed in the specification and the claims, but should be construed to include all possible embodiments along with the full scope of equivalents to which such claims are entitled.

1. An electric machine, comprising:
a static section having a control device configured to generate control signals for controlling operation of the electric machine; and
a rotor rotatably mounted relative to the static section, the rotor having at least one acquisition device for acquiring and/or generating at least one item of rotor information relating to operation of the rotor,
wherein the control signals for controlling the operation of the electric machine are generated depending on the at least one item of rotor information,
wherein the at least one item of rotor information is transmittable from the at least one acquisition device to the control device via a transmitter of the rotor and a receiver of the static section,
wherein the at least one item of rotor information is transmittable in a contact-free manner and by way of optical signals from the transmitter to the receiver, and
wherein the electric machine is configured as an externally excited synchronous machine.

2. The electric machine according to claim 1, wherein the acquisition device comprises at least one current sensor configured to acquire at least one item of current information relating to a current electrical current flowing in at least one rotor winding of the rotor as at least one of the items of rotor information.

3. The electric machine according to claim 1, wherein the acquisition device comprises at least one voltage sensor configured to acquire at least one item of voltage information relating to a current electrical voltage applied to at least one rotor winding of the rotor as at least one of the items of rotor information.

4. The electric machine according to claim 1, wherein the acquisition device comprises at least one rotational position sensor configured to acquire at least one item of rotational position information relating to a current rotational position of the rotor as at least one of the items of rotor information.

5. The electric machine according to claim 1, wherein the acquisition device comprises at least one temperature sensor configured to acquire at least one item of temperature information relating to a current temperature of the rotor as at least one of the items of rotor information.

6. The electric machine according to claim 5, wherein the at least one item of temperature information relating to the current temperature of the rotor is related to a current temperature of at least one rotor winding of the winding.

7. The electric machine according to claim 1, wherein the transmitter is configured to move along an annular trajectory during the rotation of the rotor, and
wherein the receiver is annular and is arranged next to the annular trajectory.

8. The electric machine according to claim 1, wherein the transmitter is arranged annularly and concentrically with respect to an axis of rotation of the rotor, and
wherein the receiver is arranged next to the transmitter.

9. The electric machine according to claim 1, further comprising at least one transmission device configured to inductively transmit a power from the static section to the rotor, wherein the power is for energizing at least one rotor winding of the rotor.

10. The electric machine according to claim 9, wherein the at least one transmission device has at least one stator-side induction coil and at least one rotor-side induction coil,
wherein the stator-side induction coil is connectable to an energy storage device of the motor vehicle via an inverter, the energy storage device of the motor vehicle configured to store electrical energy,
wherein the rotor-side induction coil is connected to the at least one rotor winding via a rectifier,
wherein the control device is configured to generate control signals for controlling operation of the inverter depending on the at least one item of rotor information.

11. The electric machine of claim 1, wherein the electric machine is configured to generate a drive torque for a motor vehicle, and
wherein the electric machine is connectable to a drive train of the motor vehicle.

12. A motor vehicle, comprising:
an electric machine including:
a static section having a control device configured to generate control signals for controlling operation of the electric machine; and
a rotor rotatably mounted relative to the static section, the rotor having at least one acquisition device for acquiring and/or generating at least one item of rotor information relating to operation of the rotor,
wherein the control signals for controlling the operation of the electric machine are generated depending on the at least one item of rotor information,
wherein the at least one item of rotor information is transmittable from the at least one acquisition device to the control device via a transmitter of the rotor and a receiver of the static section,
wherein the at least one item of rotor information is transmittable in a contact-free manner and by way of optical signals from the transmitter to the receiver,
wherein the electric machine is configured as an externally excited synchronous machine, and
wherein the electric machine is connected to a drive train.

13. A method for operating an electric machine, the electric machine comprising:
a static section having a control device configured to generate control signals for controlling operation of the electric machine; and
a rotor rotatably mounted relative to the static section the rotor having at least one acquisition device configured to acquire or generate at least one item of rotor information relating to the operation of the rotor,
wherein the control signals for controlling the operation of the electric machine are generated depending on the at least one item of rotor information, and
wherein the electric machine is configured as an externally excited synchronous machine,
the method comprising:
transmitting the at least one item of rotor information from the at least one acquisition device to the control device via a transmitter of the rotor and a receiver of the static section,
wherein the at least one item of rotor information is transmitted in a contact-free manner and by way of optical signals from the transmitter to the receiver.

14. The method of claim 13, wherein the electric machine is configured to generate a drive torque for a motor vehicle, and wherein the electric machine is connectable to a drive train of the motor vehicle.
